(19) United States
(12) Patent Application Publication
(10) Pub. No.: US 2009/0126681 A1
(43) Pub. Date: May 21, 2009

(54) Rotary Internal Combustion Engine

(76) Inventor: Thomas Cobb, Rancho Palos Verders, CA (US)

Correspondence Address: MARC E. HANKIN, ESQ., 11414 THURSTON CIRCLE, LOS ANGELES, CA, 90049, US

(21) Appl. No.: 11/997,299

(22) PCT Filed: Jul. 29, 2005
(86) PCT No.: PCT/US2005/027070

§ 371 Date: Jan. 29, 2008

(51) Int. Cl. F02B 53/04

(52) U.S. Cl. 123/247

(57) ABSTRACT

The present invention provides an improved rotary internal combustion engine having: a housing structure (19) with an internal stationary cavity, an intake air aperture (23), an exhaust aperture (30), an ignition aperture (21) and a fuel aperture (22) located on the surface of the stationary cavity, a rotational body (15) which contains combustion chambers (17, 18) that form internal cavities within the rotational body.

### FIELD OF INVENTION

This invention relates, generally, to combustion engines. More particularly the invention relates to rotary internal combustion engines which comprise combustion chambers located within cavities of a rotating body for improved power output and fuel efficiency.

### BACKGROUND

An expensive sports car with twelve cylinders sitting at a stop light idling is guzzling gas at an alarming rate to no good effect. Of course when the light changes the driver can step on the pedal and beat everyone to the next light. Another car driving along the freeway on cruise control is going a steady 70 miles and hour. It is unlikely that this car is using more that thirty percent of the available power, but the driver is paying for it all in gas consumption. On top of that, the driver is paying the energy bill for constantly accelerating the pistons first one way and then the other way over and over. Rotary engines have been invented with the purpose of eliminating the waste and noise of the piston engine.

Internal combustion engines are either reciprocating piston engines or rotary engines. Reciprocating piston engines use crank gears to translate movement of pistons into a rotary motion. Rotary engines, in contrast, do not require the use of crank gears because the piston performs a rotary motion during operation.

The most popular rotary engine, the Wankle rotary engine, includes a rotor having a cross-section similar to a triangle and rotates in a uniquely shaped cylinder. This engine uses the pressure of combustion to move a triangular type rotor within the rotor housing. The four cycles of conventional combustion—intake, compression, combustion and exhaust—each take place in its own portion of the rotor housing. These cycles cause the rotor to rotate an eccentric output shaft geared to the rotor. However, because of the unique shape of the cylinder, not only does the Wankle rotary engine encounter sealing problems that result in high fuel consumption but moreover, these engines are expensive to produce and maintain.

Therefore, there has been a long felt need in the art for an internal rotary combustion engine that will maximize fuel efficiency and which are cheaper to produce and maintain.

### SUMMARY OF THE INVENTION

This invention is directed towards overcoming the poor fuel consumption and expensive production and maintenance costs associated generally with rotary combustion engines.

The present invention is a rotary engine that has a housing including walls, a stationary cavity within the housing, and at least one process station, where an intake air aperture, fuel injector, spark plug and an exhaust aperture are located on a surface of the stationary cavity, for providing air intake and exhaust in and out of the first cavity; an ignition aperture is located on the surface of the stationary cavity for providing combustion, and fuel aperture is located on the surface of the stationary cavity for providing gas. The rotary engine includes a drive shaft positioned through the center of the housing, a rotational body, rotating inside the stationary cavity and sequentially passing by the intake aperture, the fuel aperture, the ignition aperture, and the exhaust aperture on the surface of the stationary housing, and where the rotation of the rotational body propels the drive shaft, with at least two combustion chambers that form internal cavities within the rotational body, where the size of the chambers are fixed and face out towards the stationary cavity.

In one embodiment of the present invention the rotary engine includes a floating paddle located adjacent to the combustion chambers

It is a feature of the present invention that the combustion chambers receive compressed air. In addition, the paddle if present will further compress the air.

In one embodiment of the invention the combustion chambers are parabolic for maximum fuel efficiency. Alternatively, the combustion chambers can be of other shapes.

Accordingly, it is an object of the present invention to provide an improved rotary engine having improved efficiency over the standard rotary engine.

It is an advantage of the present invention that it is relatively easy to manufacture and assemble and maintain over the standard rotary engine.

It is an object of the present invention to provide an improved rotary engine which is lighter in weight than the standard rotary engine or piston engine.

It is a further advantage that this invention emits a lower infra red signature compared to conventional turbine engines used in the military.

Although the preferred embodiment has been illustrated and described, it will be obvious to those skilled in the art that various modifications may be made without departing from the spirit and scope of this invention.

These and other objects, advantages, and features will become readily apparent in view of the following more detailed description.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a side view illustration of the engine casing.

FIG. 2 shows a side view illustration of an improved rotary internal combustion engine along the cut line 1B-1B.

FIG. 3 shows a side view illustration of an improved rotary internal combustion engine along the cut line 1B-1B during the compressed air stage.

FIG. 4 shows side view illustration of an improved rotary internal combustion engine along the cut line 1B-1B during the fuel injection stage.

FIG. 5 shows side view illustration of an improved rotary internal combustion engine along the cut line 1B-1B during the combustion stage.

FIG. 6 shows side view illustration of an improved rotary internal combustion engine along the cut line 1B-1B during the exhaust stage.

FIG. 7 shows a front view of a floating paddle.

FIG. 8 shows a top view of a floating paddle.

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

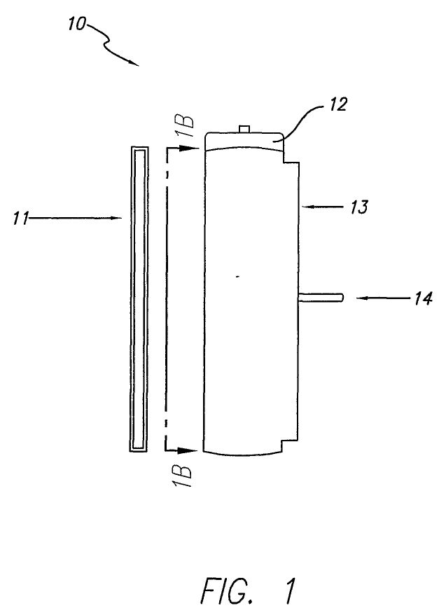

FIG. 1 is an illustration of a side view of the engine casing of the housing 10 of the rotary internal combustion engine. A face plate 11 covers the main casing 13 which has a process station 12. A drive shaft 14 is positioned through the center of the main casing 13.

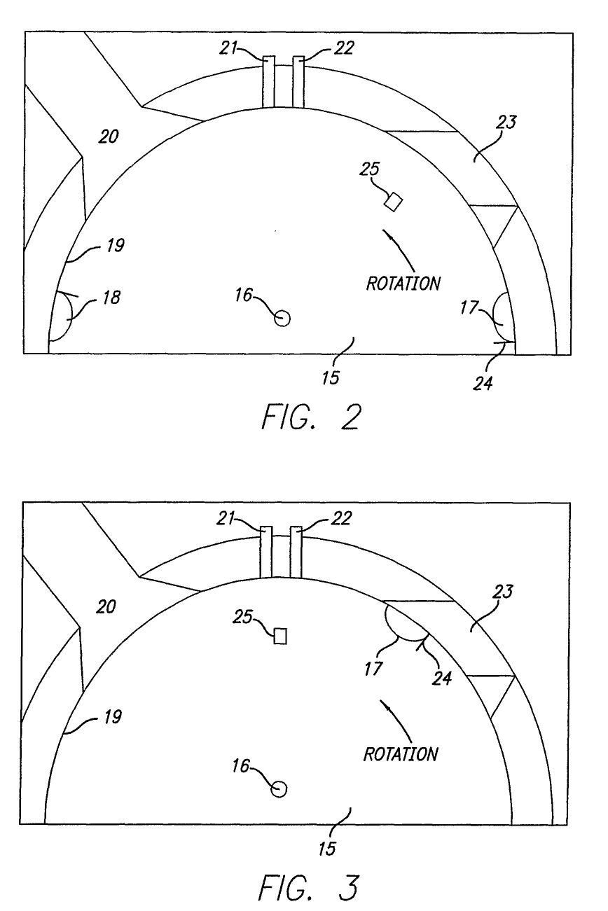

FIG. 2 shows a side view of an improved rotary internal combustion engine. The engine is composed of a rotational body (or fly wheel) 15, within an outside stationary housing 19, that rotates in a circular motion around the housing 19 and the axle 16. There are at least two combustion chambers 17 and 18 that form cavities within the fly wheel 15 that face out towards the outside housing 19. Around the outside housing 19 there is an exhaust aperture 20, an ignition aperture 21 for introducing a spark plug, an aperture for fuel introduction 22, and air intake aperture 23. These four (4) apertures taken together are defined as the process cycle station. There is a small magnet or magnetized portion of the fly wheel 25 to allow a computer to monitor the position of the rotational body in its cycle.

The operations of the rotary engine are shown in FIGS. 3, 4, 5 and 6.

FIG. 3 illustrates Step 1, the air intake stage, where the combustion chamber 17 faces the air intake aperture 23. The induced air forced into the combustion chamber would be compressed air. Compression may be achieved with the use of a conventional turbo charger possibly aided by the motion of a floating paddle 24 are located adjacent to the combustion chambers.

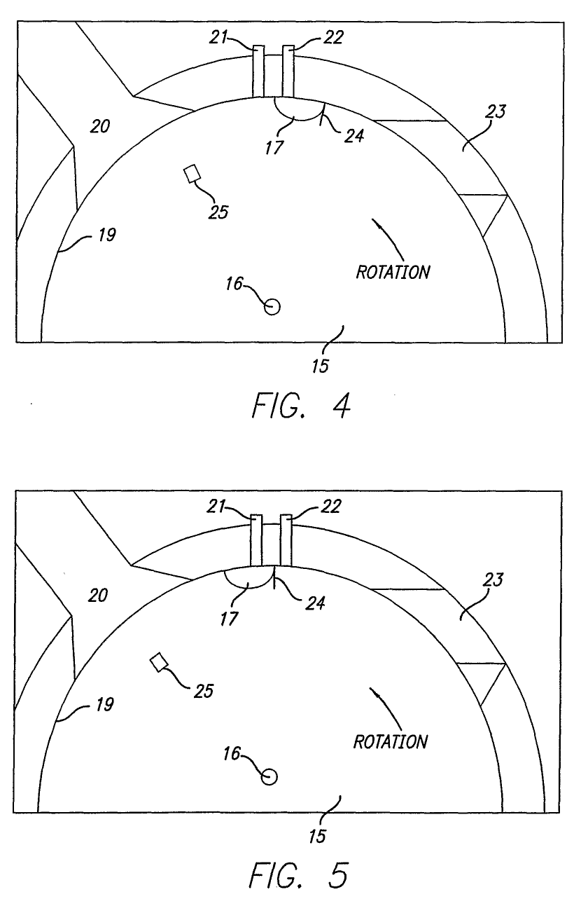

FIG. 4 illustrates Step 2, the fuel injection stage, where combustion chamber 17 faces the fuel aperture 22.

FIG. 5 illustrates Step 3 where the combustion chamber faces the ignition aperture. At this step the fuel and compressed air is ignited by sparks arising from the spark plug.

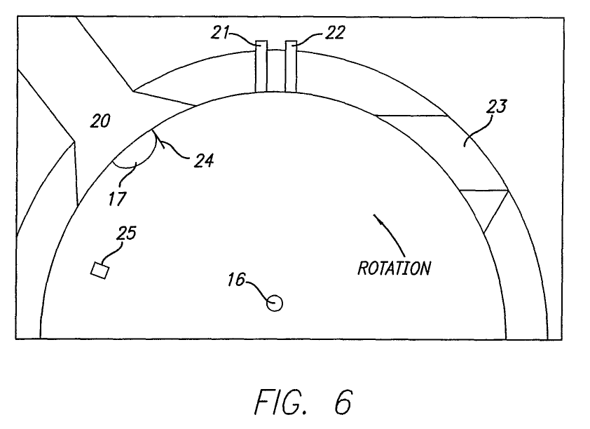

FIG. 6 illustrates Step 4 where the combusted air is released. At this point the combustion chamber 17 faces the exhaust aperture 13.

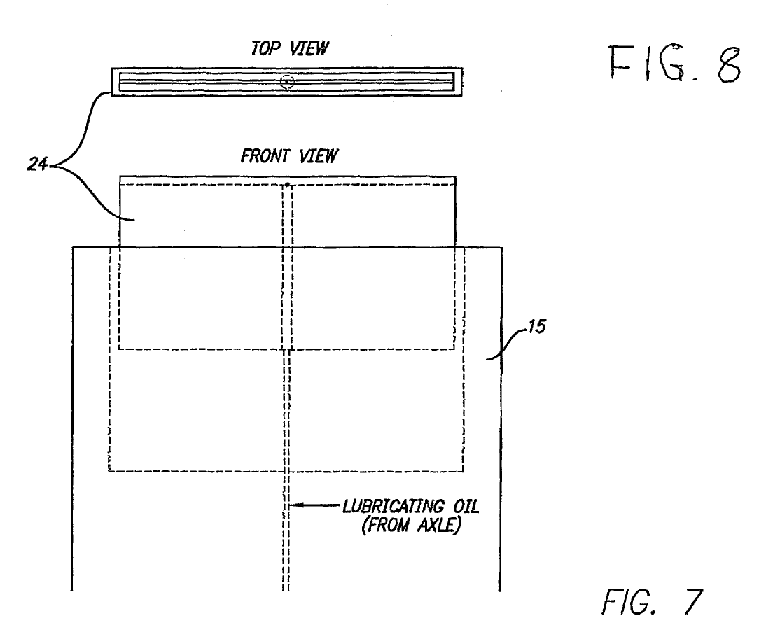

FIG. 7 shows a front view of a floating paddle 24 located adjacent to the combustion chamber within the rotational body 15. The floating paddle is forced up towards the outside housing 19 by centrifugal forces that result from the rotation of the rotational body.

FIG. 8 shows a top view of the floating paddle 24.

The difference between this rotary internal combustion engine compared to others is that the combustion chambers 17 and 18 are cavities within a flywheel 15. As the rotational body rotates, the chamber is first put in position to receive the compressed air, second then fueled, then ignited, and finally, exhausted. The rotational body would rotate very slowly during idling of the engine, or rotate very fast during high speed. Since there is no practical upper limit on how fast it could turn (limited only by the strength of the materials keeping it from exploding and the response speed of the fuel injectors) the transmission should be simpler and lighter than in other rotary engines.

Spinning of the rotational body 15 could be started by the introduction of the compressed air from the air intake aperture 23 or by a conventional starter motor. Since the entire motion is circular, the engine would run significantly quieter. The fly wheel could be balanced by having combustion chambers directly opposite each other. Although only two combustion chambers are disclosed in this embodiment, it is envisioned that a plurality could be present which are symmetrically arranged so as to balance the fly wheel. Although the combustion chambers 17 and 18 in this embodiment are parabolic for maximum fuel efficiency, the exact shape of the chambers is optional.

Lubrication could be accomplished by sending oil into the axle. Then the oil could lubricate the ball bearings on the axle and there by tubes within the rotation wheel forced by centrifugal force to the base of the paddles. The paddles would have a slight groove along the edges which would allow the oil to flow to the top of them.

There can be as many process stations that the outside housing 19 can accommodate. However, the number of process stations should not be a factor of the number of combustion chambers. This insures that at any one instance only one combustion chamber is firing.

In one embodiment of the invention, there are three process stations (P1, P 2, and P 3) and two combustion chambers (A and B). When the engine is on idle during a rotation only P1A would operate. When the computer recognizes that more power is needed the P1B combination would be activated thereby doubling the power output of the engine. As more power is required P2A would be activated along with P1A and P1B thereby increasing the power output by another 50%. Then P2A, P2B, P2A and P2B would increase the power by a third. Then 1A, 1B, 2A, 2B and 3A, would add another 25% more power. Finally, in this embodiment at maximum power you would have 1A, 1B, 2A, 2B 3A and 3B. This would add 20% more power. Note that there would be minimal penalty for reduced output, thereby greatly increasing fuel efficiency. Thus, the combination of three process stations and two combustion chambers provides the engine with variable power.

There are numerous advantages to the disclosed invention such as the size, fuel economy, pinging, weight, and simplicity.

Size—the physical size of the engine in terms of the frontal area is a fraction of a piston engine because the need for a crank and a piston is eliminated by this invention. Also the elimination of cylinders also reduces the length of the engine compared to a piston engine. Even the Wankle engine requires one rotor for each “cylinder.”

Fuel economy—since no energy is wasted in reversing direction the same amount of fuel can produce greater power or less fuel is needed to produce the same horsepower. In addition, there is very little waste associated when the engine is running at less than full throttle.

Pinging—this is essentially eliminated by the design of the invention. This in turn means that the engine would be much more tolerant of fuel variances. This could be useful in military applications where enemy stores where used.

Weight—this engine would weigh a fraction of what a piston engine of comparable horsepower would weigh since there are no cylinders. Also since the engine is capable of a much wider range of RPM's than a piston engine, the transmission can be simplified saving costs of construction and weight.

Simplicity—the rotary component is only one moving part in the power train. This should result in low maintenance rivaled only by the gas turbine.

A computer chip or ECU will monitor the position of rotational body in its rotation by sensing a magnet 25 on the rotor. The chip can be similar to one used in computers with programs in PROM to guide it. The computer will need to know the rotational position of the fly wheel. This can be accomplished by following two routines.

The first routine, Reset Routine, will be activated by an interrupt when the magnet passes a small sensing coil. The code for this routine is as follows:

Reset Routine.

Divide Register 1 by 360 giving Register 2. Note: this shows how many computer cycles equal one degree of rotation.

Move zero to Register 1 and Register 3. Note: this resets the counter and the degree counter.

Return Note: Done

The next routine is the adding routine. It is continuous and works in parallel with the reset routine. This tells the computer where in the rotation the power wheel is.

Adder Routine.

Add 1 to Register 1. Note this counts how many times we looped between interrupts.

Add Register 2 to Register 3. Note this computes the position of the wheel

Go Sub Interrogate

Go To Adder: Note: this is a deliberate infinite loop.

Between these two routines the computer will always know where the wheel is in its rotation.

Another series of routines is required to translate the desire of the driver to accelerate (or decelerate) into commands for the engine. Assuming that the an embodiment of this invention is comprised of three (3) process stations and two (2) combustion chambers (as indicated above), this would mean six (6) possible combinations of process stations and combustion chambers ( now designated as call combination 1 through 6).

There will be a routine to increase power (Gooseit) and a routine to decrease power (Coolit). The current number of combinations would be contained in a value called Running.

Constant Number of Stations=3

Constant Number of Chambers=2

Number of Values=Number of Stations*Number of Chambers
Constant Maximum=(to be determined by the fuel injector used)
Running=1 note: starting value only

```
Gooseit Routine.
    If fuel (Running) is equal to Maximum
        If Running is less than Number of Values
            Add 1 to Running
            Move 1 to fuel (Running)
        End if
    Else
        Add 1 to fuel (Running)
    End if
    Return
Coolit Routine.
    If fuel (Running) is less than 2
        If Running is greater than 1
            Subtract 1 from Running
        End If
    Else
        Subtract 1 from fuel (Running)
    End If
    Return
```

Below is a partial table to show whether the spark plug or fuel injection is being used at any one time.

| Position Low | Position High | Value | Device | Active |
|---|---|---|---|---|
| 14 degrees | 20 Degrees | 1 | 0 | Active |
| 25 degrees | 30 Degrees | 1 | 1 | Active |
| etc. | | | | |

```
    Interrogate
        Number of loops = Running * 2 Note: for the two things i.e.
spark plugs and fuel injectors
        For I = 1 to Number of Loops
            If Register 3 is Not less than Position Low (I) and Register
3 is Not Greater than Position High (I) Then
                Process Item
            Else
            If Active (I) is equal to 1
                Stop Item
            End If
        Next I
    Return
    Process Item
    If Active (I) is Not equal to 1 then
        Active (I) = 1
        If Device is equal to 0 Then
            Start Fuel Injector
        Else
            Start Spark Plug
        End If
    End If
    Return
    Stop Item
        If Device is equal to 0 then
            Stop Fuel Injector
        Else
            Stop Spark Plug
        End If
        Active (I) = 0
        Return
```

I claim:

1. An improved rotary internal combustion engine comprising:
a housing including walls, a stationary cavity within said housing, at least one process station, wherein an intake air aperture and an exhaust aperture are located on a surface of the stationary cavity, for providing compressed air intake and exhaust in and out of the cavity, an ignition aperture is located on the surface of the stationary cavity for providing combustion, and a fuel aperture is located on the surface of the stationary cavity for providing gas, a drive shaft positioned through the housing, a rotational body, rotating inside the stationary cavity and sequentially passing by the intake aperture, the fuel aperture, the ignition aperture, and the exhaust aperture on the surface of the stationary housing, and wherein the rotation of said body propels the drive shaft, and at least two combustion chambers that form internal cavities within said rotational body, wherein the size of said chambers are fixed and said chambers face out towards said stationary cavity at right angles to the radius at that point.

2. The improved internal rotary internal engine of claim 1 further comprising a floating paddle located adjacent to said combustion chambers that facilitates compression of air into said chambers.

3. The improved rotary internal engine of claim 1 wherein said combustion chambers are parabolic.

4. The improved rotary internal engine of claim 1 wherein said rotational body has an attached magnet.

5. The improved rotary internal engine of claim 1 wherein there are a plurality of said process stations to provide variable power output from said engine.

6. An improved rotary internal combustion engine comprising:
a housing including walls, a stationary cavity within said housing, at least one process station, wherein an intake air aperture and an exhaust aperture are located on a surface of the stationary cavity, for providing compressed air intake and exhaust in and out of the cavity, an ignition aperture is located on the surface of the stationary cavity for providing combustion, and a fuel aperture is located on the surface of the stationary cavity for providing gas, a drive shaft positioned through the housing, a rotational body, rotating inside the stationary cavity and sequentially passing by the intake aperture, the fuel aperture, the ignition aperture, and the exhaust aperture on the surface of the stationary housing, and wherein the rotation of said body propels the drive shaft, and at least two combustion chambers that form internal cavities within said rotational body, wherein the size of said chambers are fixed and said chambers face out towards said stationary cavity at right angles to the radius at that point, wherein said combustion chambers are parabolic, a floating paddle located adjacent to said combustion chambers that facilitates compression of air into said chambers, and wherein said rotational body has an attached magnet.

7. An improved rotary internal combustion engine comprising:
a housing including walls, a stationary cavity within said housing, a plurality of process stations, wherein each process station comprises an intake air aperture and an exhaust aperture are located on a surface of the stationary cavity, for providing compressed air intake and exhaust in and out of the cavity, an ignition aperture is located on the surface of the stationary cavity for providing combustion, and a fuel aperture is located on the surface of the stationary cavity for providing gas, a drive shaft positioned through the housing, a rotational body, rotating inside the stationary cavity and sequentially passing by the intake aperture, the fuel aperture, the ignition aperture, and the exhaust aperture on the surface of the stationary housing, and wherein the rotation of said body propels the drive shaft, and at least two combustion chambers that form internal cavities within said rotational body, wherein the size of said chambers are fixed and said chambers face out towards said stationary cavity at right angles to the radius at that point, wherein said combustion chambers are parabolic, a floating paddle located adjacent to said combustion chambers that facilitates compression of air into said chambers, and wherein said rotational body has an attached magnet.
